(19) United States
(12) Patent Application Publication
(10) Pub. No.: US 2021/0307422 A1
(43) Pub. Date: Oct. 7, 2021

(54) PROTECTIVE RESPIRATORS AND A METHOD OF MAKING A PROTECTIVE RESPIRATOR

(71) Applicants: Genevieve Dion, Philadelphia, PA (US); Richard J. Hamilton, Jenkintown, PA (US); Amy L. Stoltzfus, Kirkland, WA (US); Chelsea E. Amanatides, Philadelphia, PA (US); Keith Taylor, Philadelphia, PA (US); Leighton Cline, Philadelphia, PA (US); Sol Schade, Philadelphia, PA (US)

(72) Inventors: Genevieve Dion, Philadelphia, PA (US); Richard J. Hamilton, Jenkintown, PA (US); Amy L. Stoltzfus, Kirkland, WA (US); Chelsea E. Amanatides, Philadelphia, PA (US); Keith Taylor, Philadelphia, PA (US); Leighton Cline, Philadelphia, PA (US); Sol Schade, Philadelphia, PA (US)

(21) Appl. No.: 17/221,233

(22) Filed: Apr. 2, 2021

Related U.S. Application Data
(60) Provisional application No. 63/004,412, filed on Apr. 2, 2020.

(51) Int. Cl. A41D 13/11; A62B 9/06

(52) U.S. Cl. CPC A41D 13/1161; A41D 2500/10; A62B 9/06; A41D 13/1192

(57) ABSTRACT

A personal protective respirator comprising a facepiece housing configured to cover the nose and mouth and conform to a face of an intended wearer along a perimeter of the facepiece housing and at least two straps, wherein the facepiece housing and the straps consist of a knitted material and the facepiece housing conforms to the face of the intended wearer such that sufficient fit is achieved to attain a fit factor of at least 100 on the intended wearer according to OSHA fit testing procedures. Also, a personal protective respirator comprising a face portion configured to cover a nose and mouth of an intended wearer and to conform to a face of the intended wearer and at least four straps, wherein the mask meets NIOSH requirements for N95 respirator performance and maintains this level of performance after being washed. Finally, a method for making the noted personal protective respirators.

### CROSS REFERENCE TO RELATED APPLICATIONS

The application claims the benefit of U.S. Provisional Application No. 63/004,412, filed on Apr. 2, 2020, the entire disclosure of which is hereby incorporated by reference as if set forth fully herein.

### STATEMENT OF GOVERNMENT INTEREST

This invention was made with government support under contract no. W15QKN-16-3-0001 awarded by the United States Department of the Army. The Government has certain rights in the invention.

### TECHNICAL FIELD

The present invention relates to protective masks and respirators. In particular, the present invention relates to protective masks and respirators that are suitable for mass production and may be washable and reusable.

### BACKGROUND OF THE INVENTION

Airborne contaminants include a variety of airborne respiratory infectious diseases, such as tuberculosis and measles, severe acute respiratory syndrome (SARS) and H1N1 influenza A and Covid-19. In highly polluted areas, aerosol, which is a suspension of solid or liquid particles in gas, may be a significant airborne contaminant.

Absorption of airborne contaminants into the body can be potentially dangerous. Absorption of airborne particles through the respiratory system can cause severe health hazards. When it comes to the harmful effects of contaminants on the human respiratory system, the size of the contaminants is important. In general, smaller particles are more likely to become airborne and more dangerous. Particles larger than 10 μm usually get collected in the upper respiratory system. However, particles smaller than 10 μm are respirable and thus can reach the lower respiratory system including the lungs. Such particles may include, for example, bacteria, viruses, clay, silt, tobacco smoke and metal fumes.

One way to reduce the hazard of airborne contaminants is to wear protective equipment such as protective masks and respirators. Protective masks have been widely used by personnel in hospitals, researchers in laboratories, workers in construction sites, as well as the general public in highly polluted areas or during flu season.

According to the Centers for Disease Control and Prevention (CDC), flu viruses are spread mainly by droplets made when people with the flu cough, sneeze or talk. These droplets can land in the mouths or noses of people who are nearby or possibly be inhaled into the lungs. According to the CDC, a person might also get the flu by touching a surface or object that has the flu virus on it and then touching his/her own mouth or nose.

A protective mask usually contains a filter. The filtration efficiency depends on the particle size and the rate of airflow. Most protective masks serve as a physical barrier to filter out contaminants.

Surgical/medical masks and N95 respirators are two of the most popular masks/respirators. Studies of surgical/medical masks and N95 respirators in terms of their levels of protection and general comfort have been reported (Atrie, D. and A. Worster, Surgical mask versus N95 respirator for preventing influenza among health care workers: A randomized trial. Canadian Journal of Emergency Medicine, 2012. 14(1): p. 50-52; Baig, A. S., et al., Health care workers' views about respirator use and features that should be included in the next generation of respirators. American Journal of Infection Control, 2010. 38(1): p. 18-25).

Two specific features provide the protection level of a mask/respirator. Firstly, the filter should prevent penetration of hazardous particles of from a few nanometers to a few hundred micrometers over a range of airflow of about 10 L/min to about 100 L/min. Secondly, leakage must be avoided at the boundary of the mask and the face. Both requirements should be met in a suitable protective mask/respirator.

In order to claim a product as a surgical/medical mask, the product must pass a series of tests according to the standard such as ASTM F2100 or EN14683. For ASTM F2100, the performance of a surgical/medical mask is based on testing for (1) bacterial filtration efficiency (BFE), (2) differential pressure, (3) sub-micron particulate filtration efficiency (PFE), (4) resistance to penetration tested by synthetic blood, and (5) resistance to flammability.

For typical surgical/medical masks, and in referencing to the BFE test and the sub-micron PFE test, the filtration efficiency percentage must not be lower than 95%. The average size of the aerosol particles in the BFE test is around 3 μm while the average size of the aerosol particles in the sub-micron PFE test is around 0.1 μm.

Surgical/medical masks are not designed to seal tightly to the face. Without an adequate seal to the face, inhaled breath is not forced through the filter and instead flows through the gaps around the seal area, providing minimal protection by allowing potentially hazardous contaminants to enter the breathing zone through gaps between the wearer's face and the mask. Therefore, surgical/medical masks do not provide a sufficient degree of protection to be considered respiratory personal protective equipment (PPE).

When a high level of protection is required, respirators are usually used instead of surgical/medical masks. Respirator filters that capture at least 95% of the challenge aerosol are given a 95 rating. Those that trap at least 99% receive a 99 rating. And those that collect at least 99.97% receive a 100 rating.

In order to claim a product as an N95 respirator, the product must pass the required National Institute for Occupational Safety and Health (NIOSH) test, which is more stringent than the tests used for surgical/medical masks. Therefore, the N95 respirator provides superior protection when compared to the surgical/medical mask.

Case control studies during the 2003 SARS crisis also demonstrated that N95 respirators were more protective than surgical/medical masks against the SAR coronavirus (Lau, J. T. F., et al., SARS transmission among hospital workers in Hong Kong. Emerging Infectious Diseases, 2004. 10(2): p. 280-286; Lu, Y. T., et al., Viral load and outcome in SARS infection: the role of personal protective equipment in the emergency department. The Journal of Emergency Medicine, 2006. 30(1): p. 7-15; Nishiyama, A., et al., Risk factors for SARS infection within hospitals in Hanoi, Vietnam. Japanese Journal of Infectious Diseases, 2008. 61(5): p. 388-390; Yen, M. Y., et al., Using an integrated infection control strategy during outbreak control to minimize nosocomial infection of severe acute respiratory syndrome among healthcare workers. Journal of Hospital Infection, 2006. 62(2): p. 195-199).

Despite the high level of protection of N95 respirators, studies have shown them to be associated with overall discomfort, diminished visual, vocal, or auditory acuity, excessive humidity or heat, headaches, facial pressure, skin irritation or itchiness, excessive fatigue or exertion, malodorousness, anxiety or claustrophobia, and other interferences with occupational duties (Eck, E. K. and A. Vannier, The effect of high-efficiency particulate air respirator design on occupational health: a pilot study balancing risks in the real world. Infection Control and Hospital Epidemiology, 1997. 18(2): p. 122-127; Moore, D. M., et al., Occupational health and infection control practices related to severe acute respiratory syndrome: health care worker perceptions. Journal of the American Association of Occupational Health Nurses, 2005. 53(6): p. 257-266; Radonovich Jr, L. J., et al., Respirator tolerance in health care workers. The Journal of the American Medical Association, 2009. 301(1): p. 36-38).

Moreover, current N95 respirators and surgical mask designs that are certified by the federal government are not reusable. A respirator that meets the high standards of N95 and is also reusable is needed to minimize the number of masks that end up in landfills. Rethinking the disposable nature of personal protection equipment will prove critical, as population density and climate change bring about unprecedented challenges for humanity. Availability of reusable respirators with N95 level protection also addresses national security challenges by minimizing dependence on foreign supply of personal protective equipment (PPE) during crises. When N95 masks are needed but are in short supply, health care workers and others have had to resort to reusing disposable N95s contrary to their labeling. With a reusable, washable N95 this problem could be mitigated.

It is desirable to manufacture protective masks that combine the advantage of surgical/medical masks (i.e. low air resistance) and the advantage of N95 respirators (i.e. high protective power).

In US 2010/0313890 A1, the surgical/medical mask was provided with an additional filtering face seal that is designed to filter air before it enters the breathing zone through the top, bottom and sides of the mask.

It is an object of the invention to develop masks or respirators which meet or exceed Level 1 performance as defined in ASTM F2100 for use in healthcare settings as PPE. These masks must meet minimum standards of protection from fluid penetration, protection from airborne pathogens and particulates, breathability, and fire resistance. Additionally, another object of the present invention is to improve comfort and conformability to users' faces, thereby improving outcomes. The present invention may also provide a mask that offers re-usable, washable, non-pharmaceutical protection from seasonal allergies, or that helps to prevent people who are feeling unwell from spreading commonly encountered illnesses such as the common cold or the flu.

### SUMMARY OF THE INVENTION

In a first embodiment, the present invention relates to a personal protective respirator comprising, a facepiece housing configured to cover the nose and mouth and conform to a face of an intended wearer along a perimeter of the facepiece housing and at least two straps; wherein the facepiece housing and the straps consist of a knitted material and the facepiece housing conforms to the face of the intended wearer such that sufficient fit is achieved to attain a fit factor of at least 100 on the intended wearer according to OSHA test 1910.134 App A—Fit Testing Procedures.

In the forgoing embodiment, the face portion may comprise a nose clip.

In each of the forgoing embodiments the respirator may comprise two top straps and two bottom straps.

In each of the forgoing embodiments the housing and the straps may be a single piece of material.

In each of the forgoing embodiments the knitted material may be hydrophobic.

In each of the forgoing embodiments each of the top straps may form about a 150° angle as measured between a line extending along the length of the strap and a line extending along a section of the facepiece housing located between a bridge of the nose and the strap, and each of the bottom straps may form about a 150° angle as measured between a line extending along the length of the strap and a line extending along a section of the facepiece housing located between a bottom of the chin and the strap.

In each of the forgoing embodiments the facepiece housing may comprise a cupped region for location below the intended wearer's chin and the cupped region a first section extending from the front of the housing to a first angle, a second section extending from the first angle to a second angle, and a cheek section comprising an opening and extending from the second angle to one of the straps, wherein the first angle is about 140°, the second angle is about 150° and the third angle is about 125°.

In each of the forgoing embodiments an angle between a line extending along a section of the facepiece housing located along a bridge of the nose and a line extending along a front of the facepiece housing may be about 140°.

In a second embodiment, the present invention relates to a personal protective respirator comprising a face portion configured to cover a nose and mouth of an intended wearer and to conform to a face of the intended wearer; and at least four straps; wherein the mask meets NIOSH requirements for N95 respirator performance according to NIOSH Procedure No. TEB-APR-STP-0059, No. TEB-APR-STP-003, and No. TEB-APR-STP-007 and maintains this level of performance after being laundered in a Wascomat WUD718cc washer and a Wascomat D735 tumble dryer up to 10 times.

In the forgoing embodiments the housing and straps may consist of a knitted material and the knitted material may be hydrophobic.

In each of the forgoing embodiments the housing and straps are formed from a single piece of material.

In each of the forgoing embodiments the top straps may form about a 150° angle as measured between a line extending along the length of the strap and a line extending along a section of the facepiece housing located between a bridge of the nose and the strap, and each of the bottom straps may form about a 150° angle as measured between a line extending along the length of the strap and a line extending along a section of the facepiece housing located between a bottom of the chin and the strap.

In each of the forgoing embodiments the facepiece housing may comprise a cupped region for location below the intended wearer's chin and the cupped region a first section extending from the front of the housing to a first angle, a second section extending from the first angle to a second angle, and a third cheek section comprising an opening and extending from the second angle to one of the straps, wherein the first angle may be about 140°, the second angle may be about 150° and the third angle may be about 125°.

In each of the forgoing embodiments an angle between a line extending along a section of the facepiece housing located along a bridge of the nose and a line extending along a front of the facepiece housing may be about 140°.

In a third embodiment, the present invention relates to a method for making a personal protective respirator comprising a facepiece housing and at least a first strap and a second strap, said method comprising steps of:

i) knitting the respirator,

ii) stitching a first tube in the facepiece housing for insertion of a nose clip,

iii) one of:
a) stitching a second tube in the respirator and inserting a reinforcement structure into the second tube,
b) stitching or welding a reinforcement cup into the respirator, or
c) forming a filter into a dome and inserting the formed filter into the respirator;

iv) inserting the nose clip into the first tube; and

v) connecting the first strap to the second strap so that the connection is adjustable.

In the forgoing embodiment the connection between the first strap and the second strap may be a slide knot.

In the forgoing embodiment the connection between the first strap and the second strap may be a toggle.

In the forgoing embodiment, the facepiece housing and the first and second strap may consist of a single knitted piece.

In the forgoing embodiment, the respirator comprises a cupped region for location below the intended wearer's chin and the cupped region is knit using a flechage technique and at times a flechage technique paired with a wrap stitch technique, depending on the machine used for production. In another embodiment, the mask consists of a knitted facepiece and a filter medium. The facepiece may be produced from elastane and polyester yarns. The polyester was chosen for its hydrophobicity and washability. The use of a hydrophobic yarn provides a measure of protection from droplets such as those from coughs, as they will not wet the surface or wick through the mask. Variants of this polyester have been identified which incorporate flame retardants to satisfy CPSC flammability requirements, as well as polyester yarns with embedded antibacterial and/or antiviral agents, which provides an antimicrobial and antiviral surface. Elastane may be added to improve fit and comfort, reducing the amount of air which passes around the mask.

The filter media may, for example, be wool or polyester felts due to their dense network of randomly oriented fibers, similar to the structure of traditional filter media. Wool felts are a possible filter material, chosen for wool's antimicrobial and antiviral activity, hydrophobicity, and fire resistance. The polyester felt is a less preferred alternative but can be used due to the broader availability and higher manufacturing consistency of polyester relative to wool.

The structure of the mask includes a cup-shaped facepiece which fits around the nose and mouth, similar in form factor to the N95 respirator, providing a close fit to minimize air leakage around the edges of the mask. Ties extend from this facepiece which wrap around the top and bottom of the rear of the head. Slide knots or toggles allow the user to adjust the fit to conform to their face and to put the mask on according to hospital standards. A face seal may be added around the edge of the facepiece, optionally made from a skin-safe silicone, to further decrease air leakage.

### BRIEF DESCRIPTION OF THE DRAWINGS

FIG. 1 shows a front perspective view of an embodiment of a respirator.

FIG. 2 shows a side perspective view of the respirator shown in FIG. 1.

FIG. 3 shows a flattened side view of the respirator shown in FIG. 1.

FIG. 4 shows a back view of a wearer tightening and loosening the straps of the respirator shown in FIG. 1 behind the wearer's head.

FIG. 5 shows a side view of a wearer tightening and loosening the straps of the respirator shown in FIG. 1 around the wearer's ear.

FIG. 6 shows the inside of a respirator depicting three different locations for a seal.

FIG. 7 is a photograph showing a prior art mask in dark grey and a respirator according to an embodiment of the present invention in light grey.

FIG. 8 is a flattened side view of the respirator shown in FIG. 1 depicting the lengths and angles creating the respirator.

FIG. 9 is a flattened side view of an embodiment of a respirator depicting the lengths and angles creating the respirator.

FIG. 10 is a diagram, showing the steps to connect the straps together in a slide knot.

FIG. 11 is a top perspective view of the respirator shown in FIG. 1.

FIG. 12 is a bottom perspective view of the respirator shown in FIG. 1.

FIG. 13 is an angled bottom perspective view of the respirator shown in FIG. 1.

FIG. 14 is close-up flattened side view of the respirator shown in FIG. 1.

FIG. 15 is a photograph showing the different possible structural elements that can be used within the housing of a respirator.

FIG. 16 is a flow chart showing the prior art method of making a mask and a method of making a respirator according to an embodiment of the present invention.

FIG. 17 is a graph showing size-resolved filter efficiency test data.

### DETAILED DESCRIPTION

The invention is directed to a half-face mask or respirator created from a knit material and a method of knitting the half-face mask or respirator. The knitted respirator is preferably able to maintain its properties after being washed and is therefore, considered to be reusable. It is noted that the term “respirator” refers to a face covering that has greater ability to prevent contamination than a “mask.” However, these terms are used interchangeably throughout the description, it is specifically noted that anywhere the term “mask” is used, the term “respirator” is also meant.

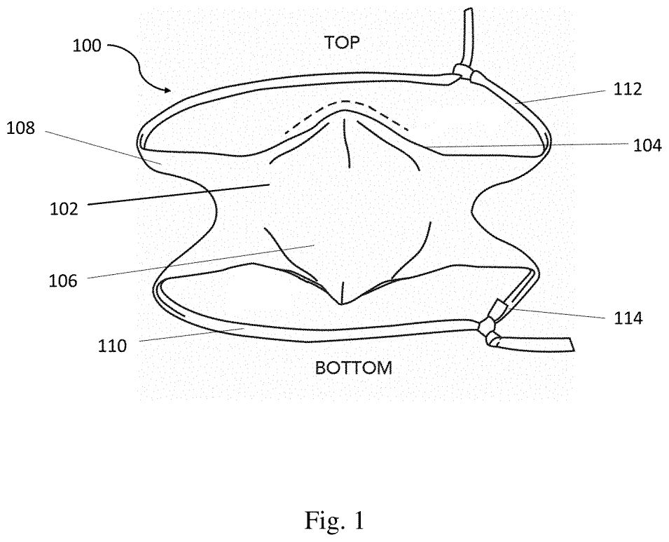

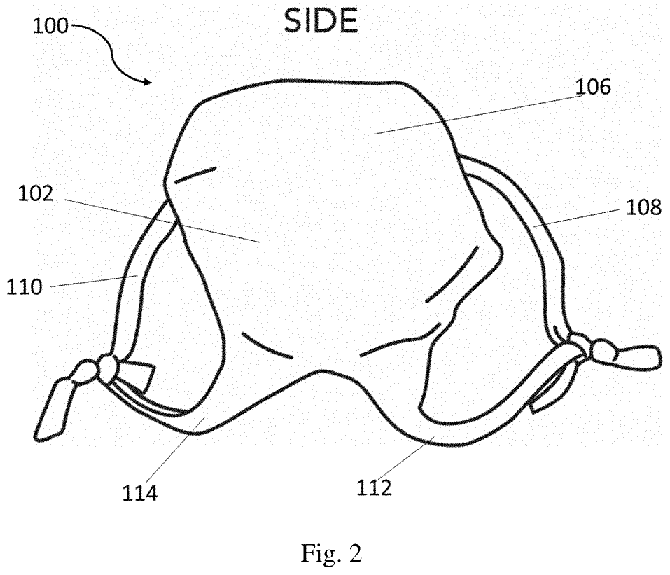

As shown in FIGS. 1-3, a first embodiment the half-face mask or respirator 100 comprises a knitted facepiece housing 102 having a three-dimensional, cup-shaped structure which sits over the wearer's nose and mouth, conforming to the wearer's face at the perimeter 104. The large, cup shaped breathing pocket 106 formed by the housing 102 sits away from the user's mouth, preventing the fabric from being suctioned to the users face during breathing, thereby improving the comfort for the wearer. The housing 102 is comprised of two layers allowing for the insertion of one or more of the following items, a filter, a nose piece, or a rigidity structure. Less fabric is knit on the interior layer of the housing than is knit on the exterior layer of the housing, therefore the interior layer of the housing has less surface area than the exterior layer of the housing, so that the interior layer may fit neatly within the exterior layer, without buckling or collapsing.

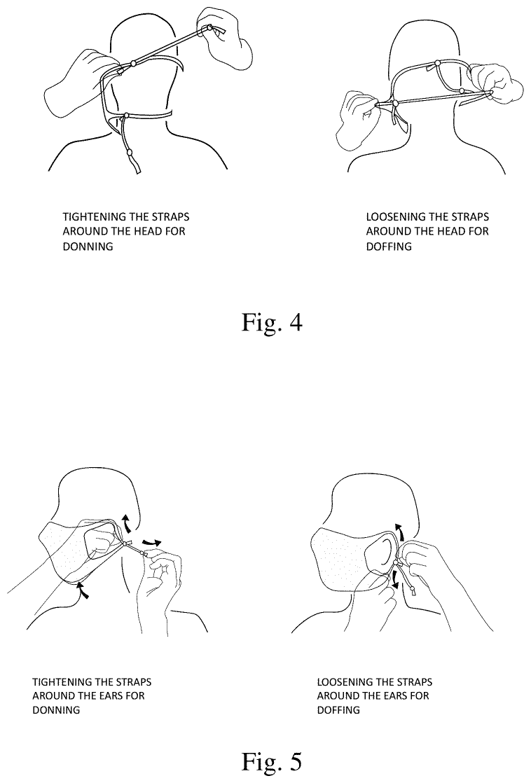

Four straps, two forming a top strap and two forming a bottom strap, are located on the sides of the mask (108, 110, 112, 114) and lead out from the corners of the housing to be fastened behind the wearer's head and neck or behind the wearer's ears, allowing the mask to be worn comfortably for extended periods of time as shown in FIGS. 4-5. The straps 108, 110, 112, 114 may have added elastane or other materials to improve the fit of the mask or enhance the comfort of the wearer.

In another embodiment of the invention the half-face mask or respirator has at least three components.

The first component of this alternative embodiment is a single-piece weft-knitted housing comprised of any knittable material (yarn). These yarns may be treated or combined with materials to provide additional properties such as anti-microbial activity, anti-viral activity, or flame resistance. This housing has a three-dimensional, cup-shaped structure which sits over the wearer's nose and mouth, conforming to the wearer's face. The cup is comprised of two layers with an opening at the top, creating a pocket. Four straps lead out from the corners of the cup to be fastened behind the wearer's head.

The second component, a malleable strip or rod (not shown), is placed in the pocket or slot within the housing above the nose, allowing the mask to seat against the wearer's nose bridge. This piece may consist of one or more solid-core metal wires, a stamped or cut metal strip, or a plastic strip. The material should be easily bent and adapted to remain in the bent position to ensure a good fit around the nose.

The third component, a set of toggles or cord locks (not shown), is used to fasten the four straps behind the wearer's head. One of several commercially available designs may be used for this component. In the preferred form, a set of two spring-loaded button toggles is used, which may be loosened or tightened with one hand to facilitate safe donning and doffing of the mask.

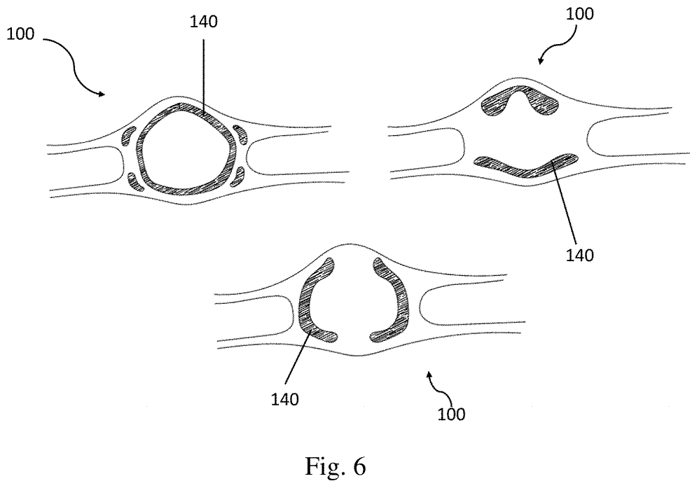

A face seal 140 as shown in FIG. 6 and described in further detail below may be added around the inner edge of the mask to improve sealing and fit against the wearer's face. This seal may include one or more strips or rings of a rubber or silicone material inside the circumference of the cup, placed such that they seat firmly against the wearer's skin to prevent air flow around the mask. A similar seal may also be added to one or both of the insides of the layers of the cup housing, to prevent the inserted filter medium from shifting in place.

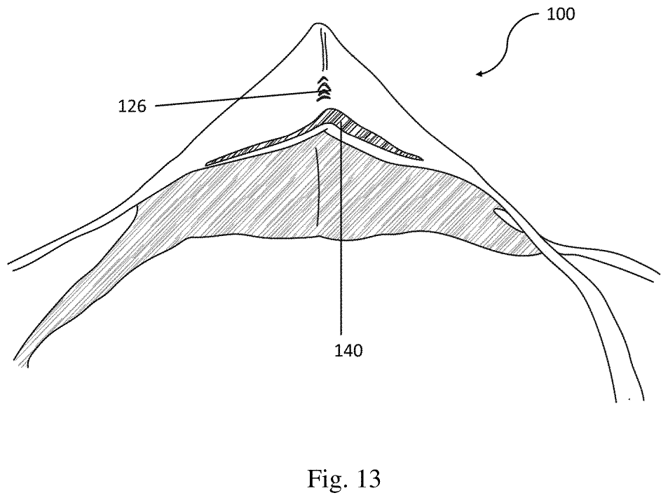

Optionally, a filter medium may be added within a pocket 116 of the mask housing 102 which is shown in FIG. 13. This filter medium may consist of traditional mask and respirator filter media such as melt-blown polypropylene or poly(tetrafluoroethylene), or felted materials such as wool and polyester. A filter stack consisting of several layers may also be used. For example, electrostatically charged layers may be employed to improve particle capture. The filter may be a form that is single-use and disposable, or a form that is reusable and washable.

The housing 102 may be reusable or disposable. In the disposable form, the filter medium may be stitched or glued in place to provide improved sealing. In the preferred form, the filter is removable and the housing 102 may be machine washed for re-use. The toggles or cord locks may be removable, if necessary for cleaning. Also contemplated for a reusable mask is a filter inserted into that housing that is not removed but can be washed along with the housing.

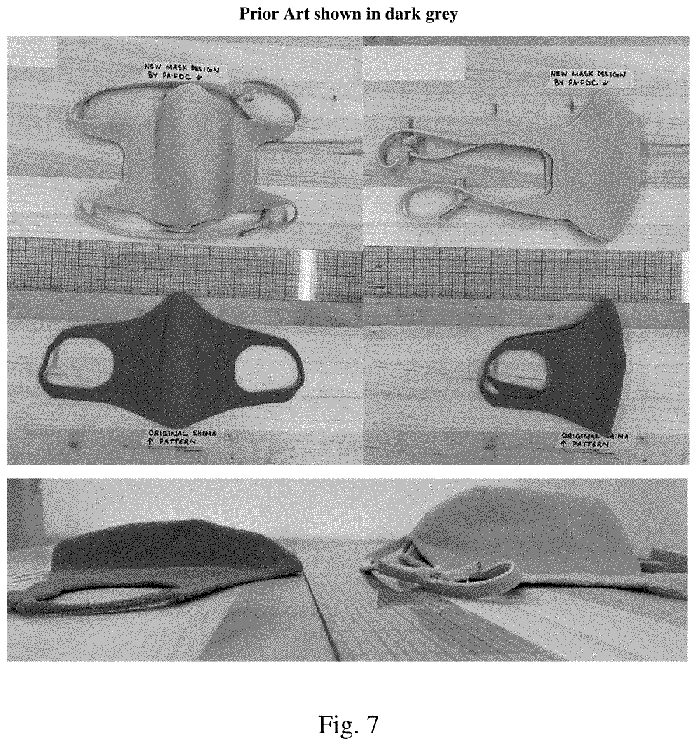

The invention is similar to a commercially available design as shown in dark grey in FIG. 7 alongside an embodiment shown in light grey of the present invention. The commercial design includes a flat face mask using ear loops to attach the mask to the wearer's face and is knitted from polyester on, for example, the Shima Seiki SWG094N2 knitting machine.

The present invention includes mask designs having several substantial differences from the commercially available design shown in FIG. 7, and the mask designs of the present invention also have superior fit and performance according to the test protocols described below.

The selected materials and particular knitted structure of the present mask provide improvements in fit and comfort over the commercial design. Additional components and manufacturing steps provide improved protection and safety to the wearer, with the preferred form at least approaching the filtration and protection level of an N95 respirator.

Preferably, the present mask is made as a single-piece knitted form. Such a fabrication process obviates the need for any sewn seams which could serve as weak points in the construction.

In another form, the components of the mask could be knitted as fabric yardage, then assembled via cut and sew methods utilizing the same form factor and creating the desirable features, such as the channel for the nose clip, via stitching.

Most preferably, the mask can be fabricated such that it qualifies as a respirator under the NIOSH test, if desired. Additionally, the mask may also be washable in that it maintains its qualification as a respirator under the NIOSH test standards after repeated washing of the mask in standard home or commercial laundering equipment, or by hand washing. Preferably, the mask maintains its qualification as a respirator after at least 10 washes using commercial laundering equipment, for example in a Wascomat WUD718cc washer and a Wascomat D735 tumble dryer.

The mask of the invention includes one or more of the following features.

### Adjustable Straps

A commercially available mask design is shown in FIG. 7. This commercially available mask holds the facepiece in place using two loops which fit over the wearer's ears. This results in a loose fit which tends to fall off the face when the wearer moves or talks. Ear loops also leave large openings at the sides of the mask through which unfiltered air can pass. To address these issues, the masks and respirators of the present invention each employ four straps 108, 110, 112 and 114, one each extending from the four corners of the mask, the top 108 and 110 and bottom 112 and 114 sets of which are joined together behind the wearer's head to form two adjustable straps as shown in FIG. 4. This provides superior fit relative to the ear loops of the original design and is consistent with the strap configurations on some commercially available respirators. Alternatively, if desired, the wearer can also attach the two side ear loops to each other behind the wearer's ears instead of behind the wearer's head as shown in FIG. 5.

In a preferred embodiment, the straps 108, 110, 112 and 114 of the present invention are integrated into the housing 102 of the mask. In this embodiment, the straps 108, 110, 112 and 114 and housing 102 of the mask 100 are knit in one continuous process, making post-knit assembly, stitching or sewing unnecessary. The straps of the mask are knitted using tubular knitting techniques. Tubular knitting techniques provide a structure that has significant stretch, which allows for greater comfort and increases the sealing properties of the mask to the face. Preferably, the mask or respirator has four straps, however, it is contemplated that two straps, one on each side of the mask would also be possible.

The ends of the four straps are finished by slicing through with a heated knife or similar tool and melting the edge to prevent the fabric from unraveling. In an alternative form, the ends of each strap could be finished using a knit bind-off procedure on the knitting machine, to prevent unraveling. The composition of the straps may differ from the cupped portion, such as by the use of elastic yarns, to improve the security, comfort, or fit of the mask.

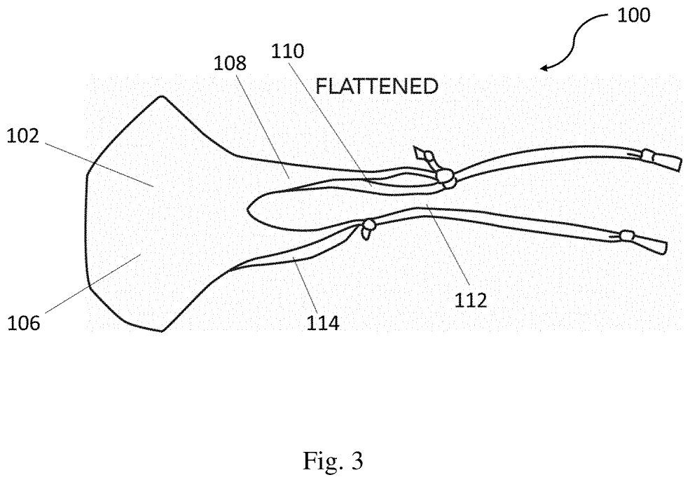

Two straps are located on each side of the mask with each side being a mirror image of the other with respect to the location of the straps on the mask. Preferably, the two straps on a single side of the mask extend approximately parallel to each other and approximately perpendicular to the line extending along the front surface of the folded “flat” mask as shown in FIG. 3.

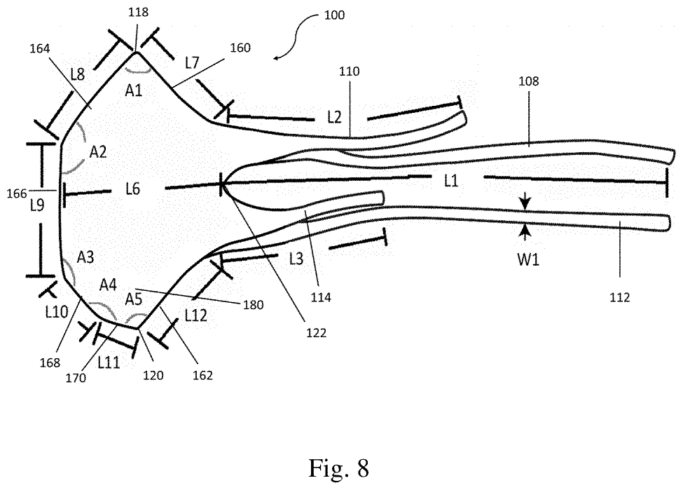

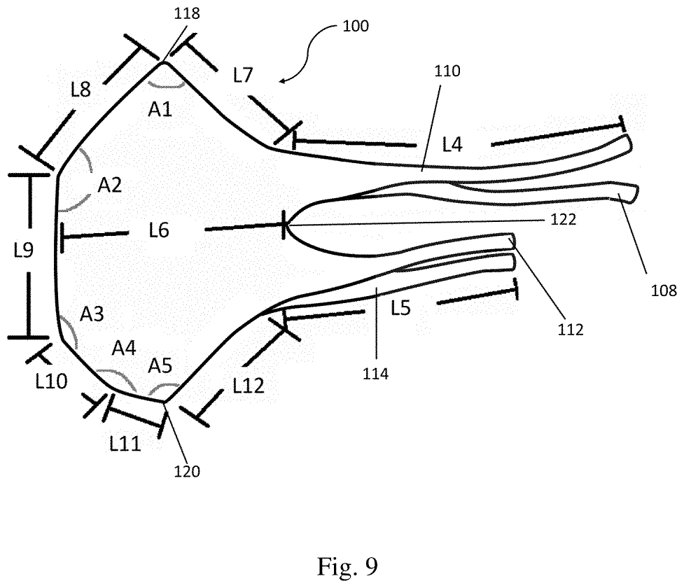

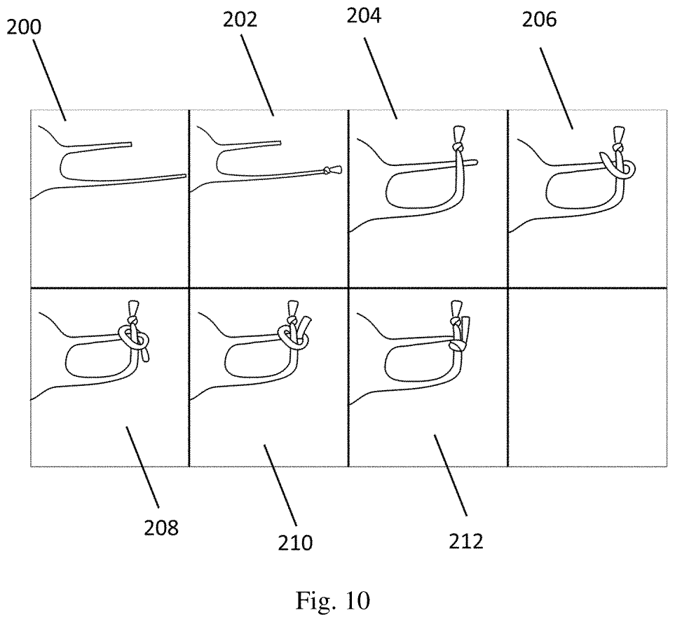

To ensure the best seal between the wearer's face and the perimeter of the housing, the straps are included in a preferred location and have a preferred angle and curvature between the straps on a single side of the face. The length of the straps is dependent on how the mask is intended to be worn, and the length may be sized up or down following garment grading principles to accommodate larger or smaller faces. Longer straps are necessary for masks in which the straps are intended to be tied behind the wearer's head, as shown in FIG. 8. Likewise, shorter straps are necessary if the straps are intended to be tied behind the wearer's ears as shown in FIG. 9.

For tying behind the wearer's head, the straps 108, 110, 112 114. may have differing lengths, as shown in FIG. 8. Although different lengths for each of the straps is preferred to reduce the use of excess material, it is understood that any length of strap may be used. Preferably, two straps 108 and 112 on one side of the mask are longer and of identical length L1 to each other, and the two straps on the other side of the mask 110 and 114 are shorter and do not have identical lengths, instead having lengths L2 and L3. The shorter straps are used to form the slide knots of the preferred embodiment on the longer straps, which allows the straps of the mask to be adjustable, and also allows for easy one-handed donning and doffing of the mask. Of the two shorter straps, the top strap 110 should be longer than the bottom strap 112 as the top strap needs to extend around the largest part of the wearer's head. The bottom strap extends around the lower portion of the wearer's head, or neck, which is typically a shorter distance. It is understood that the long straps may be on either side of the mask, or that they may be on opposite sides of the mask, so long as one is on the top of the mask and one is on the bottom.

For straps intended to be tied behind the wearer's head, the longer straps 108 and 112 preferably have a length L1 of from about 26 cm to about 30 cm, in a non-stretched state, which is approximately the distance around the wearer's head as measured from one side of the mask to the other. Most preferably, the longer straps are 28 cm long. This distance is measured from the point at which the top and bottom straps meet at the edge of the facepiece housing 120, which is approximately 10.5 cm (L6) from the front of the facepiece housing.

Preferably, the length L2 of the top shorter strap 110 is from about 10 cm to about 18 cm and more preferably, from about 12 cm to about 16 cm. Most preferably, the top strap 110 is about 14 cm long. Preferably, the length of the lower shorter 114 strap L3 is from about 7 cm to about 15 cm and more preferably from about 9 cm to about 13 cm. Most preferably, the lower shorter strap 114 is about 11 cm long.

For straps that are intended to be located behind the wearer's ears, the two top straps 108 and 110 are preferably the same size and the two bottom straps 112 and 114 are preferably the same size. The two top straps are preferably slightly shorter than the two bottom straps. Although two different lengths are preferred, it is understood that all of the straps can be the same length as well.

The length L4 of the top strap 108, 110 is the length from the side of the housing around a wearer's ear and back to the side of the housing in a non-stretched state. Preferably, this length L4 is from about 9 cm to about 14 cm and more preferably from about 10 cm to about 12 cm. Most preferably, the top straps 108, 110 are about 11.5 cm long.

The length L5 of the bottom strap 112, 114 needs to be sufficient to form a slide knot on the top strap. Preferably, the length L5 of the lower straps 112, 114 is from about 10 cm to about 18 cm and more preferably from about 12 cm to about 16 cm. Most preferably the lower straps 112, 114 are 14 cm long.

The lengths of the straps 108, 110, 112, 114 may be sized up or down following garment grading principles to accommodate larger or smaller faces.

As seen in FIGS. 8 and 9, the top straps 108, 110 start at approximately the same vertical distance from the top of the mask at the bridge 118 of the nose as the angle A2 changes at the front of the mask. Likewise, the bottom straps 112, 114 start approximately at the same vertical distance from the bottom of the mask at the chin 120 as the angle A3 changes from the front of the mask to the chin. Exact locations based on the dimensions of the facepiece housing 102 will be provided in detail below.

Each strap starts as approximately 3 cm wide where it connects to the mask and where the top and bottom straps meet. The location 122 where the top and bottom straps meet is at approximately the middle of the mask as measured from the bridge of the nose 118 to the bottom of the chin 120. Each strap then tapers to a width W1 of approximately 0.7 cm. The width W1 of the strap then remains constant for the rest of its length.

### Adjustable Cinch or Cord Stay on the Head Strap

In the mask design shown in FIG. 7, each ear loop is a continuous piece extending between two corners of the mask. In the present mask, the tie straps are in four pieces, joined to form two loops behind the head as shown in FIG. 4. These straps are joined either by tying behind the wearer's head, or by the use of a toggle or cord stay (such as the spring-loaded pieces often found, for example, on jacket drawstrings). In lieu of toggles or cord stays, the straps may also be knotted as shown in FIG. 5 to allow them to be cinched around the wearer's head with one hand, facilitating safe donning and doffing of the mask. This design represents a deviation from typical designs of commercial N95 respirators, which generally use stapled or welded elastic straps which are continuous around the head rather than being tied or joined.

In the preferred form, the mask is fastened without the need for additional materials/components added. A knotting procedure is used to create an adjustable slide knot, allowing the fit to be adjusted to each individual user. An example of how an adjustable knot may be created is shown in FIG. 10. In step one 200, the ear straps are formed or cut such that preferably the top strap is longer than the bottom strap (shown opposite in the figure). In step two 202 an overhand knot is tied in the end of the longer strap. This stops the straps from coming completely separated during use. In step three 204, the longer strap is then overlapped on top of the shorter strap. In step four 206, the shorter strap is then wrapped around the longer strap from right to left as shown in FIG. 10. In step five 208, the shorter strap then crosses behind itself and the longer strap from left to right as shown in FIG. 10. In step six 210, the shorter strap is then fed up through the loop created as it wraps around the longer strap. Finally, in step seven 212, the shorter strap is pulled to tighten it, completing the adjustable slide knot.

In one form, the straps may be joined in such a way that the two lower straps join at the back of the neck and the two upper straps join at the top of the head. In another form, the straps may be joined in such a way that the upper strap is joined to the lower strap on each side, so that the mask housing may be secured over the ears of the user.

Alternatively, a set of two spring-loaded button toggles is used, which may be loosened or tightened with one hand to facilitate safe donning and doffing of the mask. One of several commercially available designs may be used for this component.

### Mask Outline and Contour

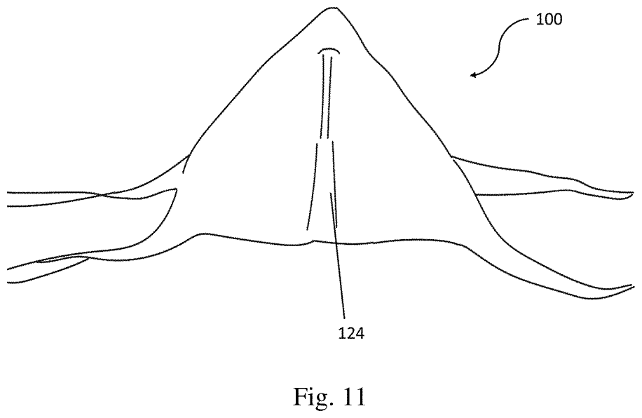

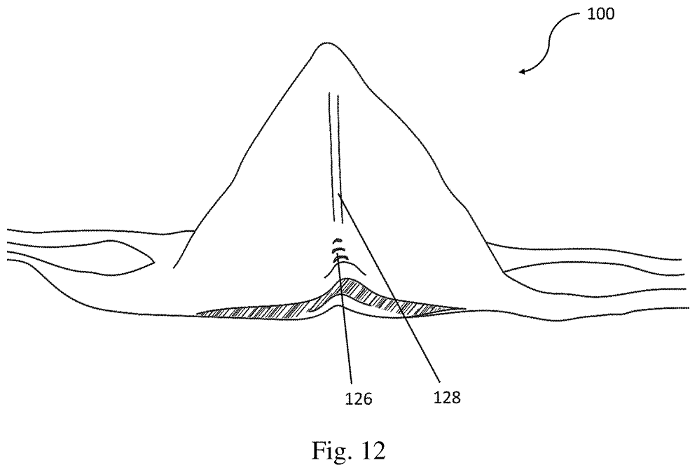

The outline and contour of the mask is adapted to provide a snug fit and allow the mask to conform closely to the shape of the wearer's face. In combination with the particular design of the straps described above, these changes aid in keeping the mask in place as the wearer moves and speaks. FIG. 11 shows a top view of an embodiment of the mask. Significantly, the angle of the fabric around the wearer's nose 124 has been adapted to better seat the mask against the bridge of the nose, thereby reducing the tendency of the mask to fall off the face in use. FIGS. 12-13 show a bottom view and an angled bottom view of an embodiment of the mask, respectively. Likewise, the angle of the fabric around the wearer's chin including a small gathering of fabric has been adapted to better seat the mask against the wearer's chin 126 creating a better seal. These angles are described in further detail below.

### The Enclosed Volume Within the Facepiece

The prior art mask shown in FIG. 7 features a facepiece which sits close to the face, providing only a small pocket around the mouth and nose. The small enclosed volume within this small pocket increases the tendency of the mask to collapse into the face and come in contact with the mouth during inhalation, as well as reducing the comfort of the mask as perceived by the wearer. In mask of the invention, a larger cup-shaped housing is provided to thereby enclose a greater volume of air within the pocket of the mask. This larger volume of enclosed air along with the shaping provided by the knitted structure reduces the tendency of the mask to collapse onto the face of the user during inhalation.

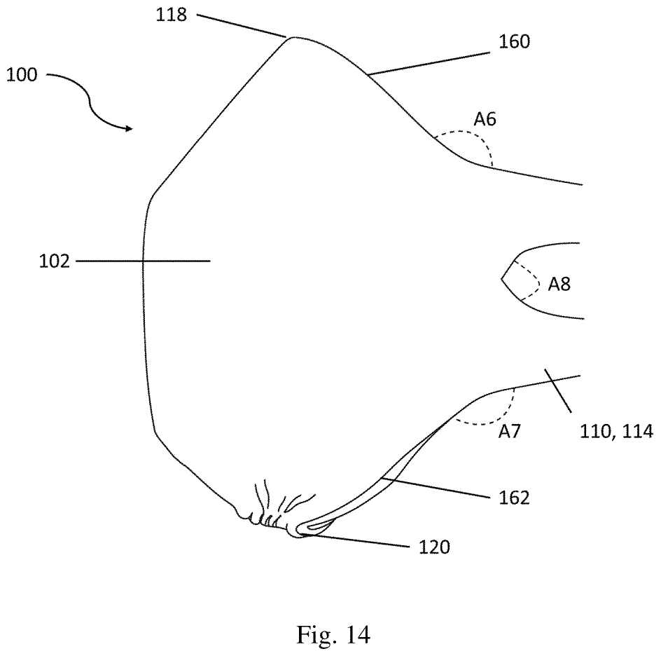

The shape of the cup, as shown most clearly in FIG. 14, has an angled top rising to the bridge of the nose 118, optionally secured with an integrated nose clip comprised of a metal or plastic insert inside the knitted body. A channel that secures the location of this nose clip is created via a continuous line of tuck stitches, selectively connecting the front and back layers of the cup, just below the top edge 150 of the mask 100, as indicated in FIG. 1. Tuck stitches also join the front and back layers of the mask housing at the cheek edges, as the body transitions into the straps.

The bottom of the cup curves below the chin 120, either in a continuous elliptical arc, or two or more angled segments as shown in FIGS. 8, 9 and 14. The cupped region transitions to the behind-ear or behind-head straps 112, 114 at an angle A7 of about 150° roughly halfway from the front of the face to the ear.

The facepiece housing consists of two layers, an exterior layer and an interior layer. Less fabric is knit on the interior layer of the housing than is knit on the exterior layer of the housing, therefore the interior layer is smaller in surface area than the exterior layer, allowing it to rest within the exterior layer without buckling, folding, or shifting during inhalation.

The shaping of the nose portion and the angle used in the design of this component of the mask were developed using flechage shaping techniques. The specific angle at the chin of the mask is achieved by pairing wrap stitching and a modified flechage technique, as discussed in further detail below.

### Mask Sizing

FIGS. 8 and 9 shows the dimensions of the mask, indicating the particular angles of the nose and chin shaping. These angles help the mask to remain on the face during talking, breathing and wearing of the mask and improve the comfort of the mask by preventing it from compressing the nose, sliding down the nose or pulling up off of the chin. As shown in FIG. 14, the angle A6 formed between a line extending along an upper cheek section 160 of the mask between the bridge of the nose 118 and the top strap 108, 110 and a line extending along the length of a top strap where the straps join the housing is about 150°. Likewise, angle A7 formed between a line extending along a lower cheek section 162 of the mask between the chin 120 and a line extending along the length of a bottom strap 112, 114 where the straps join the housing is about 150°. Additionally, a gradient of stitches connects the two straps together. The angle A8 where the two straps meet, is about 120°. These angles are specifically designed to prevent gapping of the mask at the checks and prevent air leakage.

In the side view of the “flat mask” shown in FIGS. 8 and 9 there are five angles A1, A2, A3, A4, and A5 that form the shape of the housing of the facepiece. All measurements for these angles are based on the “flat” structure shown in FIGS. 8 and 9.

The topmost angle A1 forms the top of the mask and is located at the bridge 118 of a wearer's the nose. This angle is formed by a line extending along an upper cheek section 160 and a line extending along a nose section 164, which is the section of the mask intended to be located along the front of the wearer's nose. The topmost angle A1 is about 90°.

A second angle A2 that corresponds to the end of a wearer's nose is measured between a line extending along the nose section 164 and a line extending along the front of the mask 166. This angle A2 is about 140°.

Located at the bottom of the mask is a cupped region 180 intended to be located below the intended wearer's chin. The cupped region 180 has three angles, a first cup angle A3, a second cup angle A4 and a third cup angle A5. The first cup angle A3 is formed by a line extending along the front of the mask 166 and a line extending along a first section of the cupped region 168. The first cup angle is about 140°. The second cup angle A4 is located under the wearer's chin and is measured between a line extending along the first section of the cupped region 168 and a line extending along a second section of the cupped region 170. The second cup angle is about 150°. The third cup angle A5 is also located at the bottom of the chin and is where the second section of the cupped region 170 meets a lower cheek part 162. The third cup angle A5 is measured between a line extending along the second section of the cupped region 170 and a line extending along the lower cheek section 162. The third cup angle is about 125°.

The preferred lengths of each of the straight sections of the mask as seen from the side are also shown in FIGS. 8 and 9. The length L7 of the upper cheek section 160 is about 6.3 cm, as measured from the point that the upper cheek section 160 curves into the top strap to the center of the first angle A1. The length L8 of the nose section 164 is about 6.8 cm, as measured from the center of the first angle A1 to the center of the second angle A2. The length L9 of the front of the mask 166 is about 7 cm as measured from the center of the second angle A2 to the center of the first cup angle A3.

The chin cupped region 180 starts at the first cup angle A3. The length L10 of the first cup section 168 as measured from the center of the first cup angle A3 to the center of the second cup angle A4 is about 2.8 cm. The length of the second cup section 170 as measured from the center of the second cup angle A4 to the center of the third cup angle A5 is about 2.3 cm. Finally, the length L12 of the lower cheek section 162 as measured from the center of the third cup angle to the location where the lower cheek section curves into the bottom strap 112, 114 is about 6.0 cm. A gentle curve occurs between the lower cheek section and the bottom strap 112, 114 which extends perpendicular to a line extending along the front edge of the mask. The distance L6 between the front of the mask and the point at which the two straps meet each other 122 is about 10.5 cm.

These components of the mask housing provide the 3-dimensional shape of the mask that is apparent when the mask is opened for placement on the face. FIGS. 11-13 show this dimensionality of the open mask as viewed from the top, bottom, and bottom perspective view, respectively.

The shaping of the nose and the angle used in the design of this component of the mask were developed using flechage shaping techniques as shown in FIG. 11. The area from between the top of the bridge of the nose to the curve at the front of the mask is the location of the flechage knitting 124.

The specific angle at the chin of the mask is achieved by pairing wrap stitch technique and a flechage technique as shown in FIG. 12, providing the ability for the mask to comfortably remain in place on the wearer's face while talking and moving. Specifically, the chin is created by changing the angle of the curve twice; once with flechage 128 from the front of the mask to the first angle A3 which is about 140°, and once with either a) flechage, or b) a flechage technique paired with a wrap stitch technique 126, depending on the specific machine utilized, from the first angle A3 to the next angle A4 shown in FIG. 14, which corresponds to the section of the mask under the chin. These areas of different stitching allow for the shaping of the cup which provides the previously described comfort and fit benefits. The combination of flechage and wrap stitches allow for chin shaping using angles that would otherwise be unachievable on certain knitting machines, using just flechage techniques alone.

The overall size of the mask is controlled via the knitting machine gauge, yarn properties, and knitting machine settings. It is also controlled by a finishing process in which the mask is steamed, washed, and dried, using commercial laundering equipment.

In the range of possible sizes, the pattern should be sized using garment sizing principles to conserve the aspects of fit and comfort previously described. The original size of the mask was designed so that the cup was the similar in dimension to a traditional N95 respirator, which is designed to fit 90% of the population.

### Materials

The mask is implemented using any knittable material including, but not limited to polyester, nylon, elastane, cotton, rayon, bamboo and/or wool. Although cotton may be used it is not preferred due to its hygroscopic properties since it tends to absorb moisture from the air, as well as becoming wetted when exposed to droplets such as those from a cough or sneeze. Moisture trapped by the cotton enhances the viability of microbes caught on the mask surface, which is undesirable. Preferably the mask is created from synthetic yarns, most preferably hydrophobic yarns such as polyester, which prevent or significantly reduce the tendency of the mask material to trap moisture in or on the mask. This results in a significant improvement in both the washability of the mask and the protection afforded by the mask, when compared to cotton masks.

The yarn material may also be treated or combined with materials to provide one or more additional properties such as anti-microbial activity, anti-viral activity and flame-retardant properties. Additionally, yarns used to form the mask may be engineered to facilitate surface adhesion of antiviral or antibacterial treatments. The incorporation of multiple yarn materials into the mask housing may be achieved in the following ways, examples of which include, but are not limited to; twisting together of multiple yarn materials before the knitting process, feeding multiple yarn materials through one yarn carrier, intarsia knitting and plated knitting (using one or more yarn materials).

### Addition of Permanent or Replaceable Filters

Optionally, a filter medium may be added within the pocket of the mask housing. This filter medium may consist of traditional mask and respirator filter media such as melt-blown polypropylene or poly(tetrafluoroethylene), or felted materials such as wool and polyester. A filter stack consisting of several layers may also be used, such as electrostatically charged layers to improve particle capture. Further, needle-punched polypropylene, melt-bonded polypropylene, and melt-bonded poly(tetrafluoroethylene) have been identified as further suitable filter media.

The filter medium may be a form that is single-use and disposable, or a form that is reusable and washable. Additionally, the mask housing assembly may be reusable or disposable. In the disposable form, the filter medium may be stitched or glued in place to provide improved sealing. In the preferred form, the filter is removable, and the housing may be machine washed for re-use. The toggles or cord locks may be removable if necessary, for cleaning.

A preferred embodiment of the present mask incorporates one of several filter media. In one embodiment, an ASTM-rated Level 1, 2, or 3 surgical mask may be inserted into the filter pocket of the mask to provide filtration and resistance to fluid sprays and splatters. This filter media is intended to be disposed of once degradation is noted or after a specified service life has expired.

In a washable form, the filter media should be hydrophobic to resist soiling and fouling, as well as to prevent the ingress of contaminants carried in droplets or dissolved in the washing process into the filter media and fibers.

### Face Seal

A face seal may be added around the inner edge of the mask to improve sealing and fit against the wearer's face, or inside the mask to prevent the filter from sliding around. One possible component of this seal consists of one or more strips or rings of a rubber or silicone material, or a similar material inside the circumference of the cup, placed such that the material seats firmly against the wearer's skin and prevents air flow around the mask. Alternatively, the facial seal could be achieved by selectively knitting a silicone yarn or rubber yarn material into the interior surface of the mask, causing the fabric to cling to the skin, to thereby prevent shifting of the mask. A seal could also be added, in either manner, to the insides of one or both of the layers of the cup housing, to prevent the filter medium from shifting. Possible arrangements for the seal location are shown in FIG. 6.

### Formable Nose Clip

Another possible component to help with the sealing properties of the mask may be a malleable strip or rod that is placed in a pocket or slot within the housing above the nose, allowing the mask to be adjusted to seat against the wearer's nose bridge. This piece may consist of one or more solid-core metal wires, a stamped or cut metal strip, or a plastic strip. The material chosen should be easily bent and remain in this bent position to ensure a good fit around the nose.

The formable, semi-rigid nose clip improves the fit and conformability of the facepiece against the wearer's face. This semi-rigid nose clip may also be integrated into the material of the facepiece of the mask.

Preferably, the clip consists of one or more plastic coated wires integrated with the knitted textile around the wearer's nose and shaped to allow the mask to fit around the curves of the wearer's face in this region to reduce or eliminate leakage, as well as prevent exhaled air from bypassing the mask towards the wearer's eyes and fogging eyewear lenses. The clip should be located parallel to the top edge of the mask and be located within the top about 1 cm of the mask. If a pocket for the insertion of a separate clip is provided, the stitch should be approximately one centimeter from the top edge of the mask. The distance from the edge of the mask should be sufficient for the nose clip material to be inserted and the pocket should be sufficiently small to hold the clip in place against the top of the mask. Preferably, the nose clip extends on either side of the nose to a location on the wearer's cheek bone. This location allows for the clip to also bend to conform to the curve between the nose and cheek, as well as to bend over the bridge of the nose.

### Structural Rigidity of the Mask

To facilitate the provision of a large enclosed volume within the facepiece and to help decrease the tendency of the mask to collapse onto the nose and mouth during inhalation, the structure of the facepiece of the present masks incorporate material to provide greater rigidity of the facepiece as compared to the commercial mask shown in FIG. 4 to thereby maintain the cupped shape of the facepiece.

Beyond the changes to the materials and structures described above that are implemented in the mask to improve rigidity, the mask may incorporate other features designed to prevent the mask from collapsing against the wearer's mouth and nose upon inhalation. In one embodiment, this is accomplished through the use of a denser stitch structure to produce a heavier and more rigid fabric.

Further improvements in rigidity may be realized through one of the following three methods. In one form, the incorporation of stitched or ultrasonically welded regions provides stiffer regions supporting the cupped structure in which the filter is housed. The welded regions that provide additional support could run across the width of the cup housing from side to side and/or top to bottom, for example.

In another form, semi-rigid members 300 such as the plastic-coated wires as used in the nose bridge are added to provide a cage-like structure within the cupped facepiece. This can be used alone, or with a stiffening fabric 302, such as a filter material.

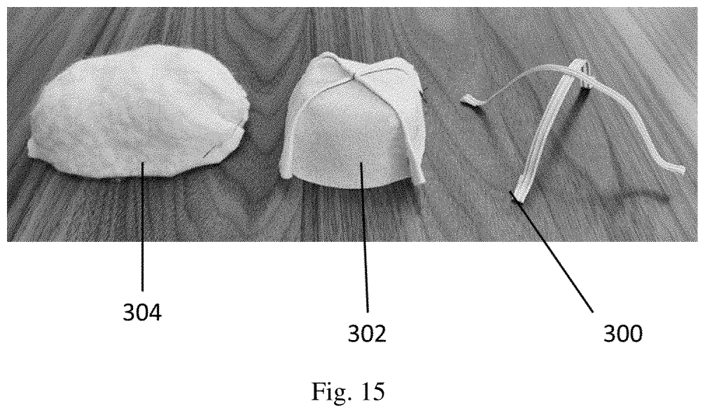

In a third form, the filter itself is molded 304 or formed into a semi-rigid or rigid domed structure which provides the desired stiffness to the facepiece of the mask. These structures are illustrated in FIG. 15.

### Manufacturing Method to Facilitate Incorporated Features

To facilitate the incorporation of one or more of the features described above, special steps have been implemented in the manufacturing process. Preferably, the entire mask is knitted in a single piece, with no sewn or otherwise post-processed components. However, it is understood that knitting components individually and then sewing the pieces together is also possible. For integration of the nose clip, a channel is sewn or ultrasonically welded along the upper edge of the mask through which the coated wires can be inserted. A similar method is used to facilitate the integration of the coated wires for use in the semi-rigid cage form of facepiece reinforcement. The sewn or welded regions of the reinforced dome-shaped filter insert may also be fabricated through the use of these methods.

The formed dome-shaped filter may be produced by a vacuum or steam forming step with the filter media placed over a mold to impart the domed shape.

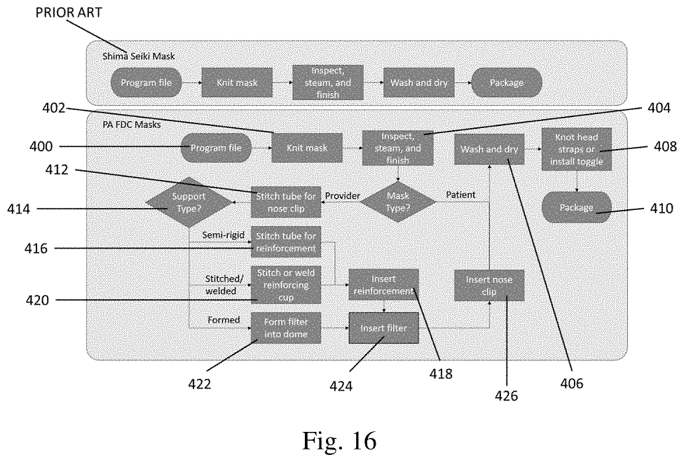

FIG. 16 is a flow chart of the method for making the commercial mask shown in FIG. 7 (prior art—top box) and also a flow chart of the method of the present invention showing how to make the mask of the invention (bottom box).

For the present invention the mask or respirator is created using a knitting machine, such as the Shima Seiki SWG094N2 knitting machine. The first step 400 is providing the program file to the machine. A person of ordinary skill in the art of programming a knitting machine is capable of producing a program according to the structures and information provided herein. The machine then knits the mask 402 according to the program. Once, the pattern of the mask is complete, the masks are inspected steamed and finished 404.

At this point, for masks that do not need to provide as much protection, they can be washed and dried 406. After being dried the straps are either tied with the appropriate slide knot, or toggles are installed on the straps 408. This mask is then complete and can be packaged 410 for transport, sale, or other purpose.

For masks that require more structure and higher performance additional steps are followed after the mask is steamed and finished 404. Not in any particular order, a stitch 412 is made to form a tube on the top portion of the mask. The tube is used to house a nose clip, which allows the mask to better conform to the shape of the bridge of the wearer's nose eliminating a possible area where air may escape or enter the facepiece area without traveling though the mask. Alternatively, the nose clip can be integrally formed when the mask is knitted.

Additional processing of this mask may also include adding a support structure to the mask 414. As discussed above, the additional structure can be provided by providing a support structure within one or more tubes stitched into the fabric 416. In a preferred form, the tubes are stitched into the fabric in an X-shape across the housing of the facepiece. However, other patterns are contemplated, including the use of a single reinforcement tube located in any direction across the wearer's nose or mouth as a line or other curved shape. Additionally, the use of more than two reinforcement tubes is also contemplated. The reinforcement structure is then added to the tubes at step 418.

A second method of reinforcing the housing of the facepiece can be providing additional stitching or welding to the housing 420. Such stitching, or welding increases the stability of the knitted structure.

Finally, as a third option, a rigid or semi-rigid filter or other cup-shaped structure can be inserted between the two layers of the housing. For this method the filter can be formed at step 422, or a filter having the proper shape may be obtained from another location and just inserted into the mask at this time 424.

More than one of these options can be utilized on a mask structure. However, it is preferable to use only one method to save production costs and time.

The nose clip is also inserted 426 if necessary and not already a part of the mask structure. Finally, to complete the mask, the mask is washed and dried 406, the straps are connected 408 and the finished product is packaged 410.

### Testing Protocols

A series of tests have been used to both qualitatively and quantitatively document the performance of the modified mask structures for the purpose of evaluating the potential ability of the masks to meet FDA and NIOSH requirements to be used as personal protective equipment (PPE). For qualitative testing, a test program in compliance with OSHA respirator fit testing guidelines has been implemented, involving the release of an aerosol of saccharine in an enclosed hood. The wearer inhales through the mask and reports whether the saccharine could be tasted or smelled. A negative result indicates effective filtration.

Quantitative testing is being conducted in two forms. The first form, used for preliminary assessment of new prototypes, is a quantitative respirator fit test according to OSHA guidelines (OSHA test 1910.134 App A—Fit Testing Procedures). In this test, a TSI PortaCount 8030 respirator fit tester is used. This instrument samples the air outside and inside a respirator during use and determines a “fit factor”, or the ratio of aerosol concentrations outside and inside the respirator. Scores on this metric are compared to those from N95 respirators.

The second form of quantitative testing currently in use is particulate filtration efficiency testing, using a method analogous to, though not fully conforming with, ASTM F2299. In this test, the combined mask and filter medium are clamped flat within a test fixture and exposed in a sealed chamber to smoke generated from burning incense. A TSI Model 3091 Fast Mobility Particle Scanner is used to sample air from within the chamber, alternatingly sampling directly from the chamber and through the filter. The size-resolved particulate concentrations in the unfiltered and filtered air are recorded, with the ratio of concentrations between the unfiltered and filtered air being computed to give the filtration efficiency across a range of particulate sizes. This differs from the standard ASTM F2299 method used in certifying masks in the use of a broad dispersion of particle sizes, since the ASTM method specifies the use of aerosolized 100 nanometer diameter latex spheres as the test particulate.

These test methods are used as preliminary testing methods to inform the selection of filter media and design of the mask.

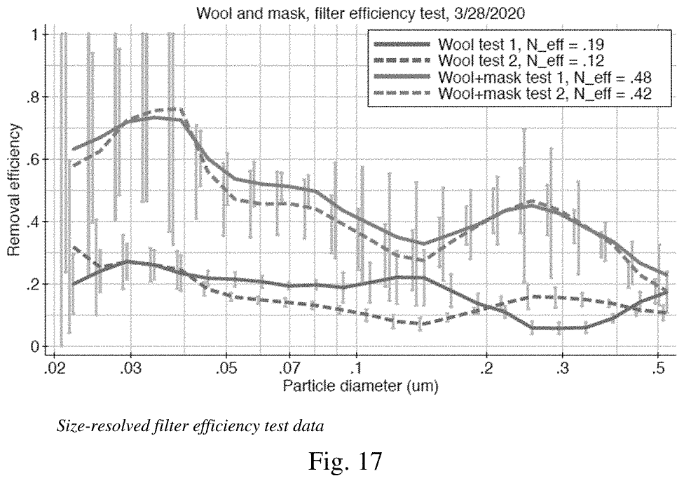

As shown in FIG. 17 there are significant differences in the resulting mask structures. The differences in the mask structures result in functional changes to the mask and improvements in performance relative to the commercially available mask shown in FIG. 4. In testing, the mask with an ASTM Level 1 facemask installed as a filter medium provides a reduction in aerosols equivalent to an N95 respirator.

Quantitative fit tests of the mask using the filter medium manufactured by North Carolina State University show a fit factor of 200 under normal breathing, comparable to the fit factor of an N95 respirator. Fit factors of 90-150 have been observed using ASTM Level 1 surgical masks as a filter medium in the mask. Preliminary filtration efficiency tests show that the mask structure provides an additional 25-30% filtration efficiency above the bare filter media at the 100 nanometer particle size used in ASTM F2299 testing and NIOSH N95 certification tests. Certain testing methods can be employed to evaluate the performance of the masks or respirators. For example, the masks/respirators can be evaluated using the ASTM 1, 2 and 3 face mask performance levels.

A differential pressure measurement is provided during the particle filtration efficiency test described above, with a digital manometer incorporated across the filter in the test setup. EN 14683:2019, Annex C specifies a flow rate of 8 L/min through a 25 mm diameter sample, within the 10 L/min capacity of the test equipment.

For certification as a surgical mask (ASTM protection levels 1-3), tests of fluid resistance to ASTM F1862 will need to be performed. To test differential pressure, the FDA recommends testing to Mil-M36945C-4.4.1.1.1. In ASTM F2100, testing to EN 14683:2019, Annex C, is suggested.

Attention is paid to the comfort of the mask, and a subjective assessment of how cool or warm the mask feels to wear. Basing this subjective assessment on the FDA Part 510(k) Premarket Clearance guidelines for surgical masks, the mask is categorized into one of the following descriptions: very cool, cool, warm, very warm, or hot. Commercially available N95 respirators are used as a point of comparison, representing a “hot” mask. Cooler designs are preferred, with a requirement that the mask feel subjectively cooler than the N95 respirator.

Flammability testing is conducted using a setup which approximates the CPSC-191-53 standard, as specified by 16 CFR Part 1610. The apparatus used consists of a bracket into which a textile may be clamped, exposing a 2″ wide by 6″ long test section. The bracket is mounted at a 45-degree incline, and a butane lighter is fixed at the base, aligned with the lower edge of the textile. The lighter is lit for one to two seconds, until the textile has ignited. A stopwatch is used to track the time needed for the flame front to reach 5″ along the length of the test section, with a mark on the fixture indicating the 5″ point.

1. A personal protective respirator comprising:
a facepiece housing configured to cover the nose and mouth and conform to a face of an intended wearer along a perimeter of the facepiece housing; and
at least two straps;
wherein the facepiece housing and the straps consist of a knitted material and the facepiece housing conforms to the face of the intended wearer such that sufficient fit is achieved to attain a fit factor of at least 100 on the intended wearer according to OSHA test 1910.134 App A—Fit Testing Procedures.

2. The respirator of claim 1 wherein, the face portion comprises a nose clip.

3. The respirator of claim 1 comprising two top straps and two bottom straps.

4. The respirator of claim 1 wherein the housing and straps are a single piece of material.

5. The respirator of claim 1 wherein the knitted material is hydrophobic.

6. The respirator of claim 3, wherein each of the top straps forms about a 150° angle as measured between a line extending along the length of the strap and a line extending along a section of the facepiece housing located between a bridge of the nose and the strap, and each of the bottom straps forms about a 150° angle as measured between a line extending along the length of the strap and a line extending along a section of the facepiece housing located between a bottom of the chin and the strap.

7. The respirator of claim 1, wherein the facepiece housing comprises a cupped region for location below the intended wearer's chin and the cupped region a first section extending from the front of the housing to a first angle, a second section extending from the first angle to a second angle, and a third cheek section comprising an opening and extending from the second angle to one of the straps, wherein the first angle is about 140°, the second angle is about 150° and the third angle is about 125°.

8. The respirator of claim 1, wherein an angle between a line extending along a section of the facepiece housing located along a bridge of the nose and a line extending along a front of the facepiece housing is about 140°.

9. A personal protective respirator comprising:
a face portion configured to cover a nose and mouth of an intended wearer and to conform to a face of the intended wearer; and
at least four straps;
wherein the mask meets NIOSH requirements for N95 respirator performance according to NIOSH Procedure No. TEB-APR-STP-0059, No. TEB-APR-STP-003, and No. TEB-APR-STP-007 and maintains this level of performance after being laundered in a Wascomat WUD718cc washer and a Wascomat D735 tumble dryer up to 10 times.

10. The respirator of claim 9 wherein the housing and straps consist of a knitted material.

11. The respirator of claim 9 wherein the housing and straps are formed from a single piece of material.

12. The respirator of claim 10 wherein the knitted material is hydrophobic.

13. The respirator of claim 9, wherein each of the top straps forms about a 150° angle as measured between a line extending along the length of the strap and a line extending along a section of the facepiece housing located between a bridge of the nose and the strap, and each of the bottom straps forms about a 150° angle as measured between a line extending along the length of the strap and a line extending along a section of the facepiece housing located between a bottom of the chin and the strap.

14. The respirator of claim 9, wherein the facepiece housing comprises a cupped region for location below the intended wearer's chin and the cupped region a first section extending from the front of the housing to a first angle, a second section extending from the first angle to a second angle, and a third cheek section comprising an opening and extending from the second angle to one of the straps, wherein the first angle is about 140°, the second angle is about 150° and the third angle is about 125°.

15. The respirator of claim 9, wherein an angle between a line extending along a section of the facepiece housing located along a bridge of the nose and a line extending along a front of the facepiece housing is about 140°.

16. A method for making a personal protective respirator comprising a facepiece housing and at least a first strap and a second strap, said method comprising steps of:
i) knitting the respirator,
ii) stitching a first tube in the facepiece housing for insertion of a nose clip,
iii) one of:
d) stitching a second tube in the respirator and inserting a reinforcement structure into the second tube,
e) stitching or welding a reinforcement cup into the respirator, or
f) forming a filter into a dome and inserting the formed filter into the respirator;
iv) inserting the nose clip into the first tube; and
v) connecting the first strap to the second strap so that the connection is adjustable.

17. The method for making a personal protective respirator of claim 16, wherein the connection between the first strap and the second strap is a slide knot.

18. The method for making a personal protective respirator of claim 16, wherein the connection between the first strap and the second strap is a toggle.

19. The method for making a personal protective respirator of claim 16, wherein the facepiece housing, the tubes, and the first and second strap consist of a single knitted piece.

20. The method for making a personal protective respirator of claim 16, wherein the respirator comprises a cupped region for location below the intended wearer's chin and the cupped region is knit using a flechage and/or flechage pair with a wrap stitch technique.
